(19) United States
(12) Patent Application Publication
(10) Pub. No.: US 2025/0115388 A1
(43) Pub. Date: Apr. 10, 2025

(54) LABEL PRINTER APPLICATOR FOR A CONVEYOR SYSTEM

(71) Applicant: Dematic Corp., Grand Rapids, MI (US)

(72) Inventors: Harry T. German, Belding, MI (US); Tyler Ernest, Cedar Springs, MI (US); Travis Smith, Comstock Park, MI (US); Joseph Russell, Jenison, MI (US); Spencer Knizacky, Grand Rapids, MI (US)

(21) Appl. No.: 18/480,610

(22) Filed: Oct. 4, 2023

(51) Int. Cl. B65C 9/28; B65C 9/40

(52) U.S. Cl. CPC B65C 9/28; B65C 2009/407

(57) ABSTRACT

A method of labeling an asset supported on a conveyor includes printing a label, affixing the printed label to an asset at a first location along the conveyor, transporting the asset to second location along the conveyor, and delivering fluid flow to at least a region of the printed label when the asset is transported to the second location to correct irregularities formed in the label.

### TECHNICAL FIELD

The disclosure related generally to label printer applicator systems, and, in particular, to a conveyor system and method for labeling a plurality of assets.

### BACKGROUND

Distribution centers typically have a conveyor system which is configured to transport assets such as boxes, containers, pouches, or the like along a fixed path to an outbound location (e.g. order picking, sortation, packing, shipping, dispatch).

A label printer applicator system configured to print and apply a label to the assets is provided. As the asset travels along the fixed path, the system controller coupled to the label printer applicator system sends an instruction to the label printer applicator system to perform these tasks including print, release, and apply a label to the asset. However, the label being applied to the asset tends to come off while continues to travel along the path thereby causes a jam to the conveyor system. What is needed is a conveyor system and method for labeling a plurality of assets.

### SUMMARY

A label printer applicator system configured to print and apply a label to the assets is provided.

In one embodiment, a conveyor system for labeling a plurality of assets includes a conveyor for conveying one or more assets and a label printer applicator system located above the conveyor. The label printer applicator system includes a first label applicator module that is configured to print a label and affix the printed label to one or more assets and a second label applicator module that is spaced apart from the first label applicator module. The second label applicator module is configured to deliver fluid flow along a region of the printed label to correct irregularities formed around the region.

### BRIEF DESCRIPTION OF THE DRAWINGS

Below, exemplary embodiments of the disclosure are described in detail with reference to the figures.

FIG. 1A is a perspective view of a conveyor system with an integrated label printer applicator system according to an exemplary embodiment of the disclosure;

FIG. 1B is a side elevation view of the conveyor and the integrated label printer applicator system of FIG. 1A with first and second label applicator modules;

FIG. 1C is an enlarged bottom plan view of the second applicator module illustrating the arrangement of the heads of the second applicator of FIG. 1B;

FIG. 1D is an enlarged side view of the second applicator module illustrating the operation of the second applicator module of the integrated label printer applicator system;

FIG. 1E is a perspective view of the conveyor system illustrating the operation of the second applicator module of the integrated label printer applicator system according to another exemplary embodiment of the disclosure;

FIG. 1F is a side elevation view of the conveyor and the integrated label printer applicator system of FIG. 1E;

FIG. 1G is an enlarged bottom plan view of the second label applicator module illustrating the arrangement of the heads of the second label applicator module of FIG. 1E;

FIG. 1H is an enlarged side elevation view of the second label applicator module of FIG. 1F;

FIG. 1I is a perspective view of a conveyor system with an integrated label printer applicator system according to another embodiment of the disclosure;

FIG. 1J is a side elevation view of the conveyor and the integrated label printer applicator system of FIG. 1I;

FIG. 1K is an enlarged bottom plan view of the second label applicator module of FIG. 1J;

FIG. 1L is an enlarged side elevation view of the conveyor and the integrated label printer applicator system of FIG. 1J illustrating the operation of the second label applicator module of FIG. 1J;

FIG. 1M is a perspective view of a conveyor system with an integrated label printer applicator system according to another embodiment of the disclosure;

FIG. 1N is a side elevation view of the conveyor and the integrated label printer applicator system of FIG. 1M;

FIG. 1O is an enlarged bottom plan view of the second label applicator module of FIG. 1N;

FIG. 2 is a perspective view of a conveyor system with an integrated label printer applicator system according to another exemplary embodiment of the disclosure;

FIG. 3 is a perspective view of a conveyor system with an integrated label printer applicator system according to yet another exemplary embodiment of the disclosure;

FIG. 4A is a perspective view of a conveyor system with an integrated label printer applicator system according to yet another exemplary embodiment of the disclosure;

FIG. 4B is a side elevation view of the conveyor and the integrated label printer applicator system of FIG. 4A;

FIG. 4C is perspective view to FIG. 4A illustrating the movement of the head;

FIG. 4D is a similar view to FIG. 4B illustrating the movement of the head;

FIG. 5 is a side elevation view of a conveyor system with an integrated label printer applicator system according to another exemplary embodiment of the disclosure;

FIG. 6 is an enlarged view of another head mounting arrangement;

FIG. 7A is an enlarged perspective view of yet another embodiment of a head mounting arrangement;

FIG. 7B is a side view of the head mounting arrangement of FIG. 7A; and

FIG. 7C is a similar view to FIG. 7A illustrating the movement of the head.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alternations and modifications to the illustrated embodiments and includes further applications of the principles of the disclosure as would normally occur to a person of ordinary skill in the art to which this disclosure pertains.

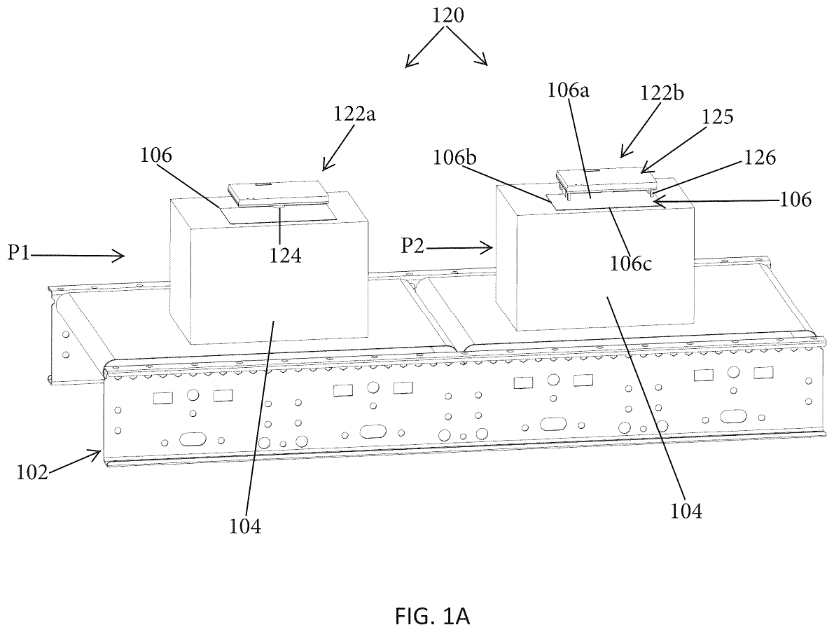

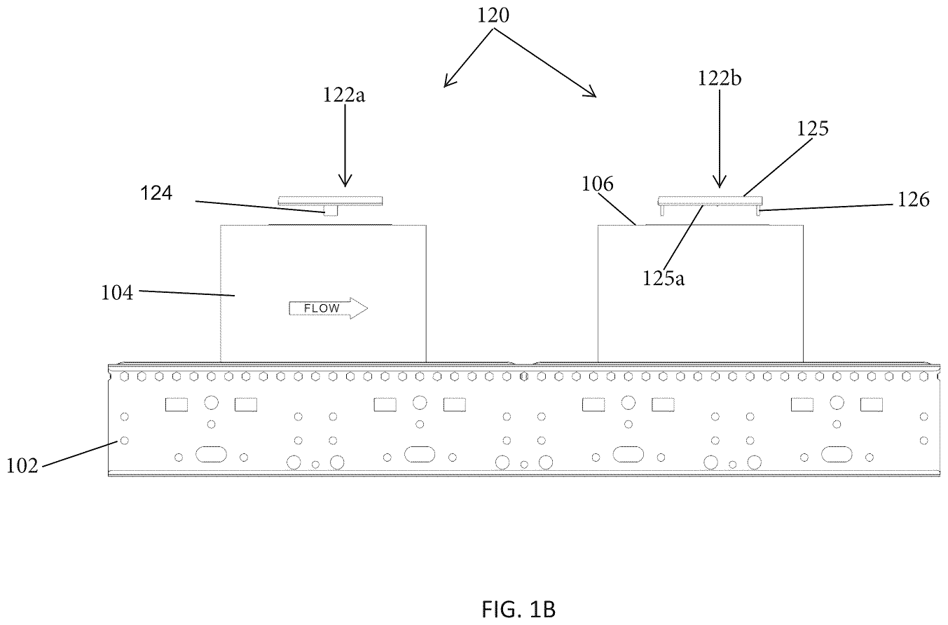

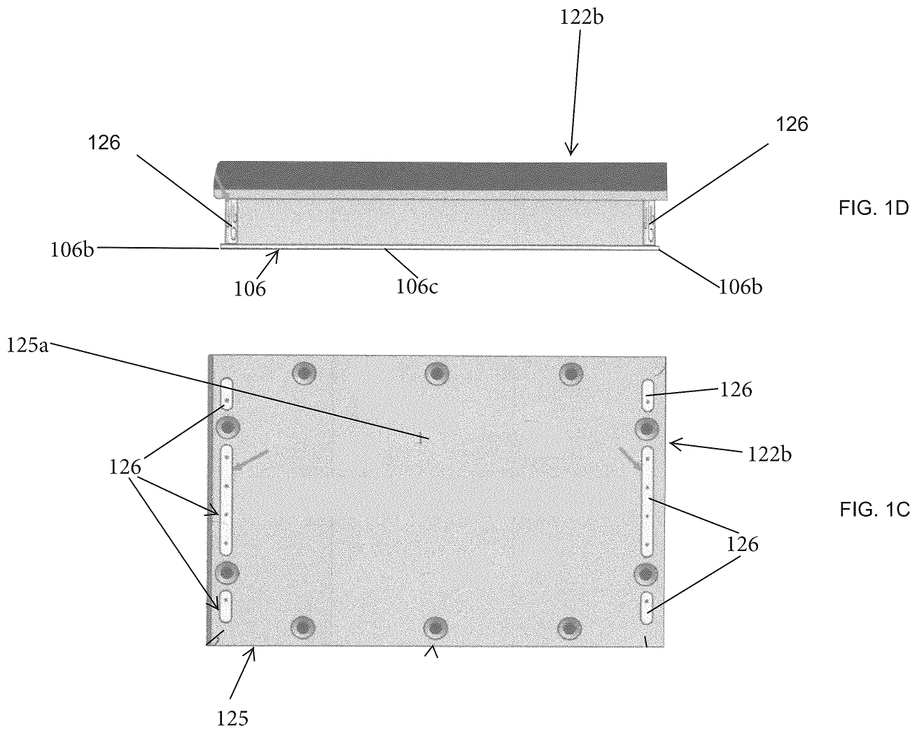

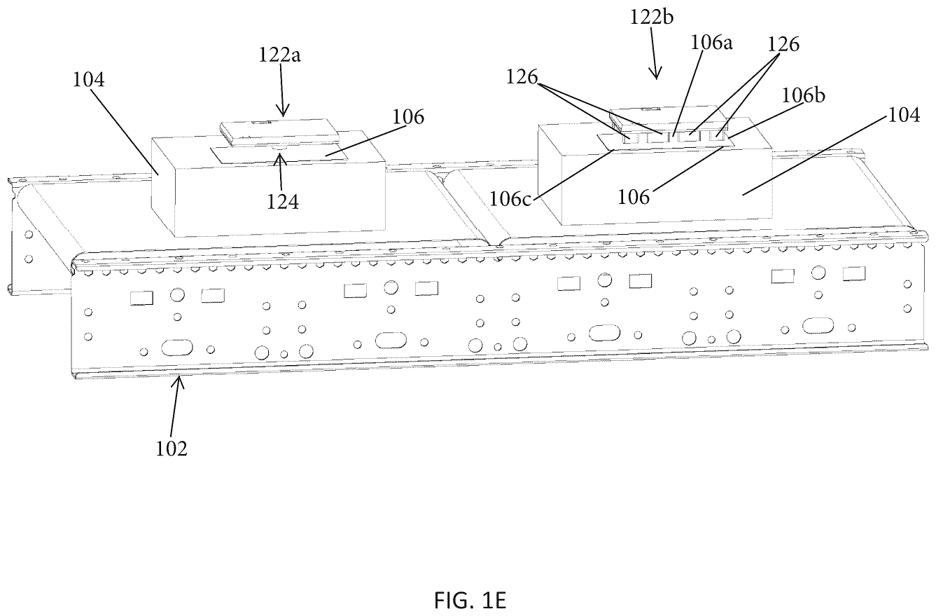

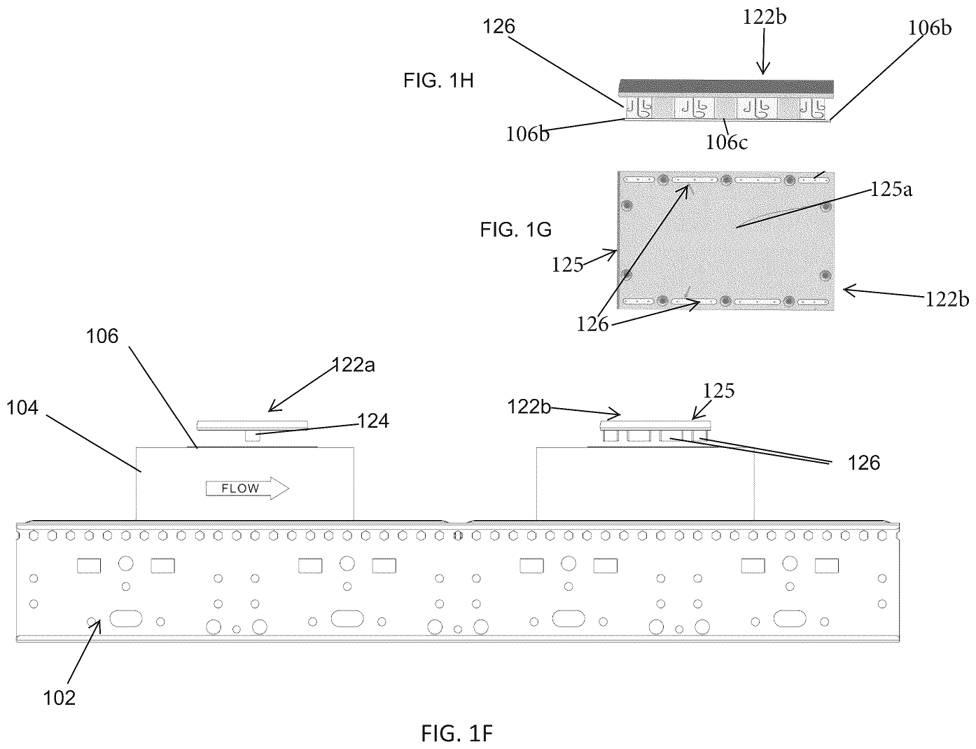

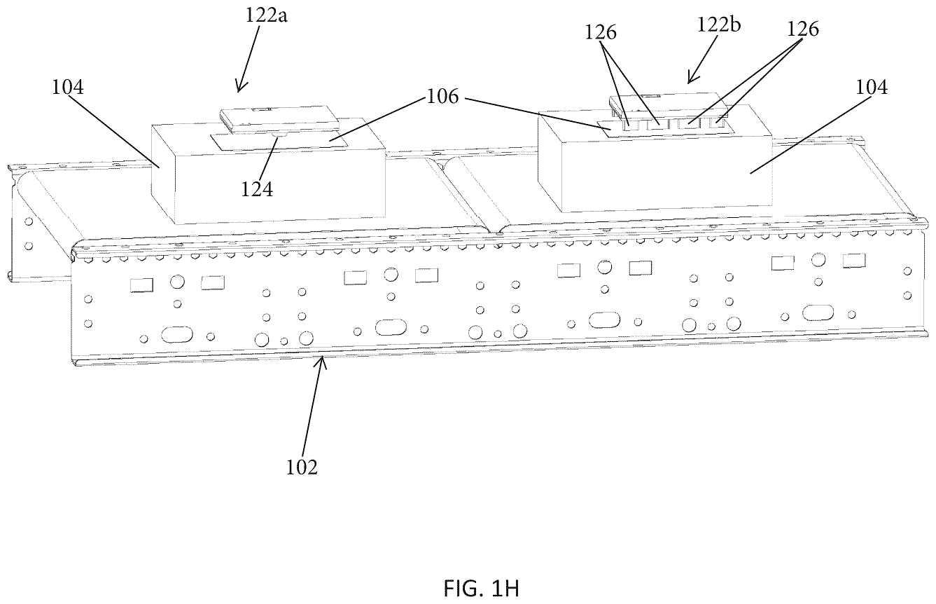

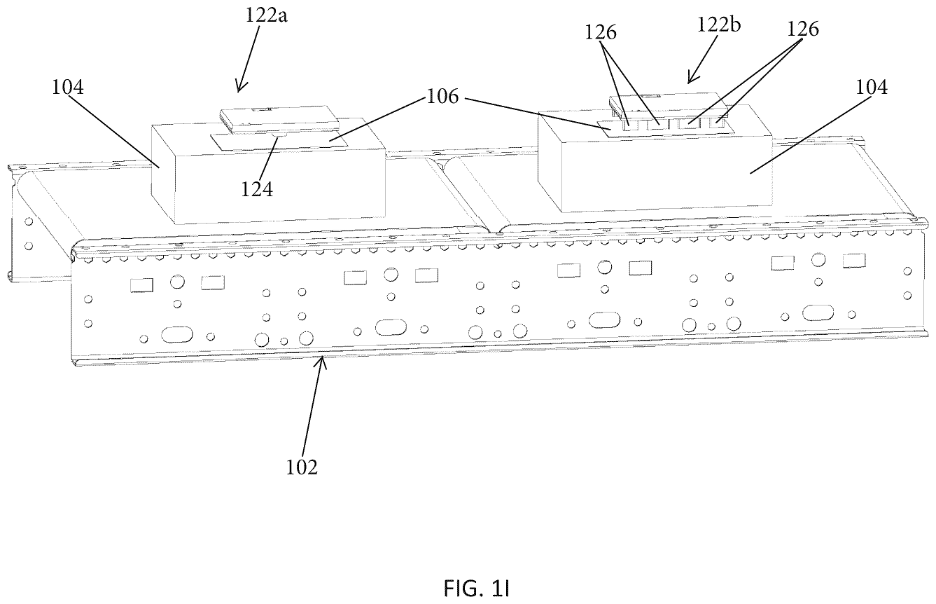

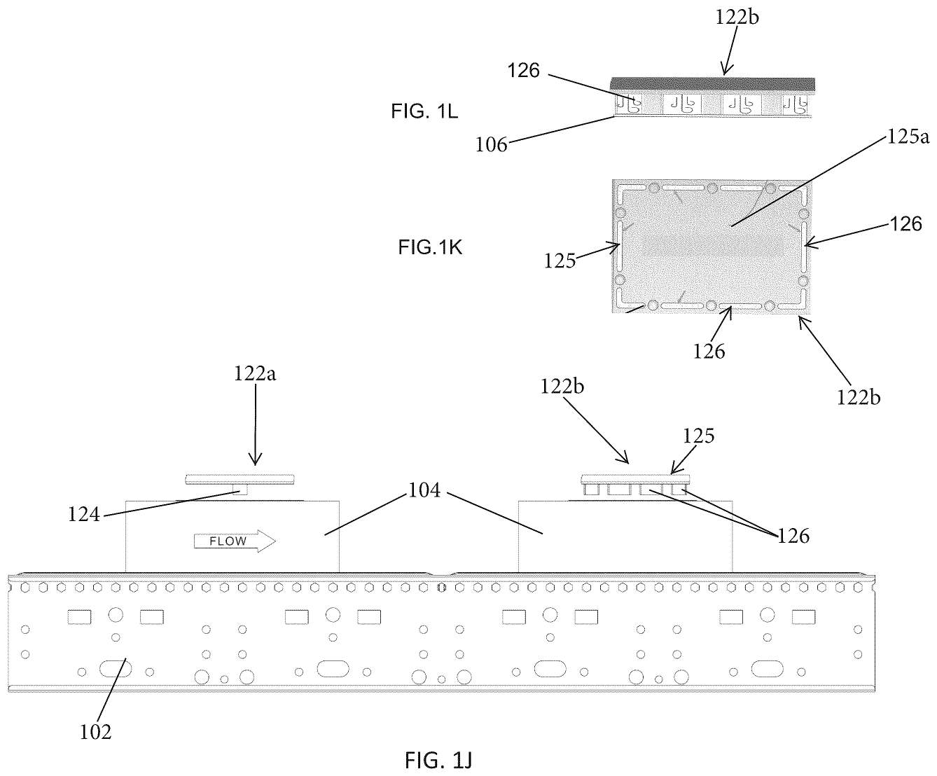

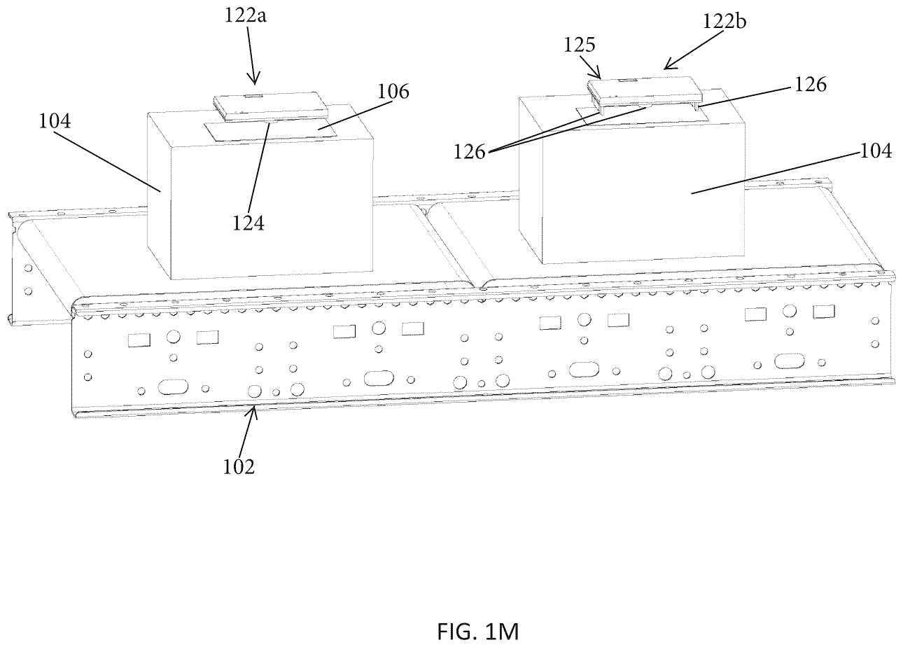

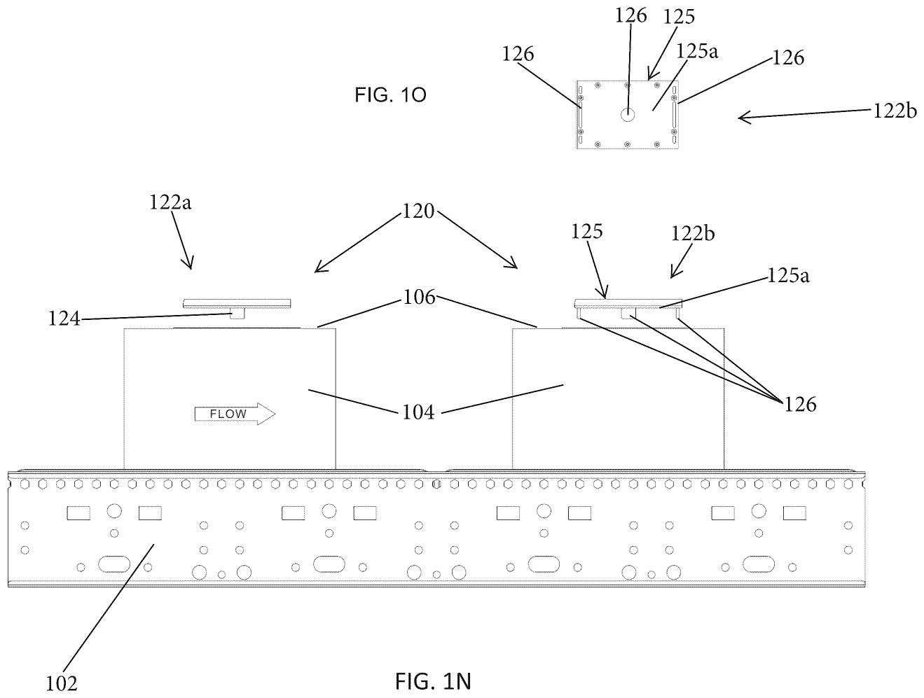

Referring to FIGS. 1A and 1B, a conveyor system 100 with an integrated label printer applicator system 120 according to one embodiment of the disclosure is depicted. The conveyor system 100 includes a conveyor path 102, such as formed by a conveyor belt or the like, which is arranged to form a continuous, fixed path. In some implementations, the conveyor system 100 may include two or more conveyor belts that are arranged side-by-side, parallel, perpendicular, offset, or positioned with one belt above the other belt. The conveyor system 100 is configured to transport a plurality of assets 104 along the conveyor path 102. Workstation (not shown) is arranged along the conveyor path. The workstation includes automated machines, such as robots, humanoids, or the like to perform one or more tasks in relation to the assets 104 as the assets travel along the conveyor path 102 and/or pass by the workstation. The assets 104 may have various shapes, sizes, heights, and weights and, for example, may be boxes, containers, pouches, or the like, each having one or more items contained therein.

The label printer applicator system 120 is mounted or located above the conveyor path and is communicatively coupled to the workstation. In one embodiment, the label printer applicator system 120 may be communicatively coupled to a controller (not shown). A series of computer-implemented instruction may be transmitted to the label printer applicator system 120 from the workstation and/or controller to perform one or more tasks.

As shown in FIGS. 1A and 1B, the label printer applicator system 120 includes a first label applicator module 122a and a second label applicator module 122b spaced apart from each other. In one embodiment, both the modules 122a, 122b receive instruction from one of the workstation or the controller. In another embodiment, the module 122a receives instruction from the workstation, and the module 122b receives instruction from the controller. In a further embodiment, the instruction may be sent to the modules 122a, 122b via the controller remotely located elsewhere or outside a facility (such as a distribution center, storage facility, a supply chain center, a manufacturing facility, a warehouse facility, or the like). In the illustrated embodiment, the first label applicator module 122a is a label printer applicator, and the second label applicator module 122b is a fluid label applicator.

As the asset 104 travels in the direction P1 of conveyor path travel, the first label printer applicator module 122a is activated and begins to print a label 106 that corresponds to the asset 104. In one embodiment, a head 124 of the first label printer applicator module 122a performs a process on a center or middle portion 106a (FIG. 1C) on the label 106 to affix the label 106. The asset 104 continues to travel in the direction P2 of the conveyor belt travel until it is about to reach the second label applicator module 122b. Unlike the first label applicator module 122a, the second label applicator module 122b includes at least one head 126 that is arranged to apply a curing process on a predetermined layout of the label 106. The curing process, as illustrated, is the use of air. Optionally, fluid label applicator module 122b includes a housing 125 with a wall 125a facing the conveyor and the label, which supports head or heads 126. For example, each head 126 may comprise a nozzle, an air knife blower, a fan, or the like which is mounted in wall 125a of housing 125.

In one embodiment, the predetermined layout is formed by leading and trailing edges 106b of label 106 wherein air flows through the head or heads 126 to impinge on the edges 106b to firmly affix the label 106 to the asset 104, as depicted in FIGS. 1C and 1D.

In another embodiment of the second label applicator module, the predetermined layout is opposed longitudinal edges 106c of the label 106. As the asset 104 travels along in the direction P2 and below the second label applicator module 122b, the air flows through the heads 126 and impinges on the longitudinal edges 106c to affix the label 106 to the asset 104, as understood from FIG. 1H and the layout of the heads illustrated in FIG. 1G.

In yet another embodiment of the second label applicator module, the heads 126 are arranged to direct air onto a predetermined layout that includes the leading and trailing edges 106b and longitudinal edges 106c of label 106 to effectively extend around the circumference of the label 106. Air flow through the heads 126 impinges on the circumference and affixes the label 106 to the asset 104 as understood from FIG. 1L and the layout of the heads 126 as illustrated in FIG. 1K. The label 106 may have a substantially square, or otherwise rectangular, shape with somewhat rounded corners.

In one embodiment of the second label applicator module, the predetermined layout includes leading and trailing (lateral) edges 106b and a central portion 106a of label 106 and wherein air flow through the heads 126 impinges on the edges 106b, as well as the central portion 106a of label 106, to firmly affix the label 106 to the asset 104, as understood from the layout of heads 126 depicted in FIG. 1O.

In some implementations, the label 106 may be substantially round, circular, oval, shape without edges, sides, and/or corners. Although a use of airflow process is performed and illustrated as above, other processes such as heating, exposure to light, and use of catalyst may be performed on the label 106 without departing the scope of the disclosure.

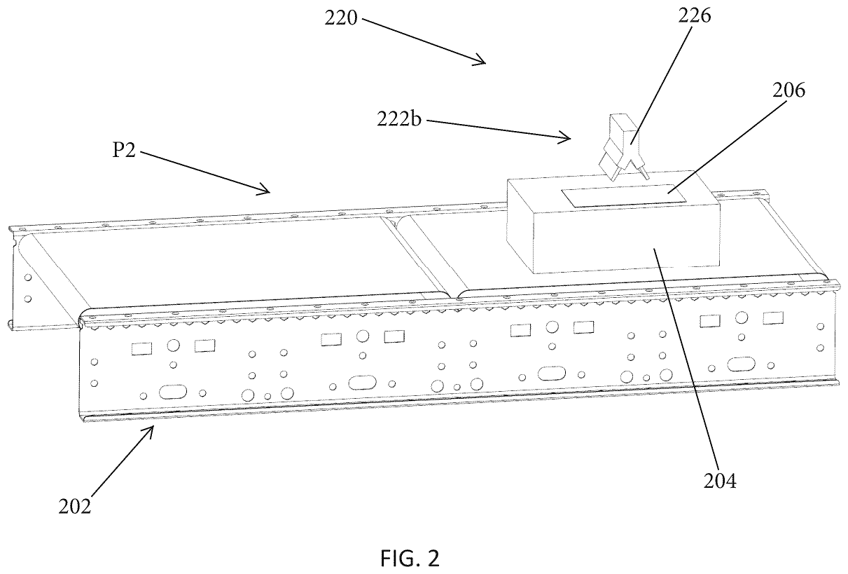

FIG. 2 shows a second label printer applicator system 220 with a second label applicator module 222b in which head 226 comprises a dual head. For exemplary details of the first label applicator module of label printer applicator system 220, reference is made to the first embodiment. Unlike from a single head (where a single stream of airflow is provided) air flow from head 226 is divided into two air streams, which flow in opposite directions from the dual head 226, with each stream of air that is emitted from the dual head 226 preferably substantially at an offset angle to the direction in which the air flow passes through at least part of an interior passageway (not shown). As can be seen, the streams of air flow emitted from the dual head 226 are targeted and projected onto opposed portions of the label 206 so that the airflow impinges evenly on and affix the label 206 firmly to the asset 204, such as a box, as the asset 204 travels along in the direction P2 of conveyor belt travel.

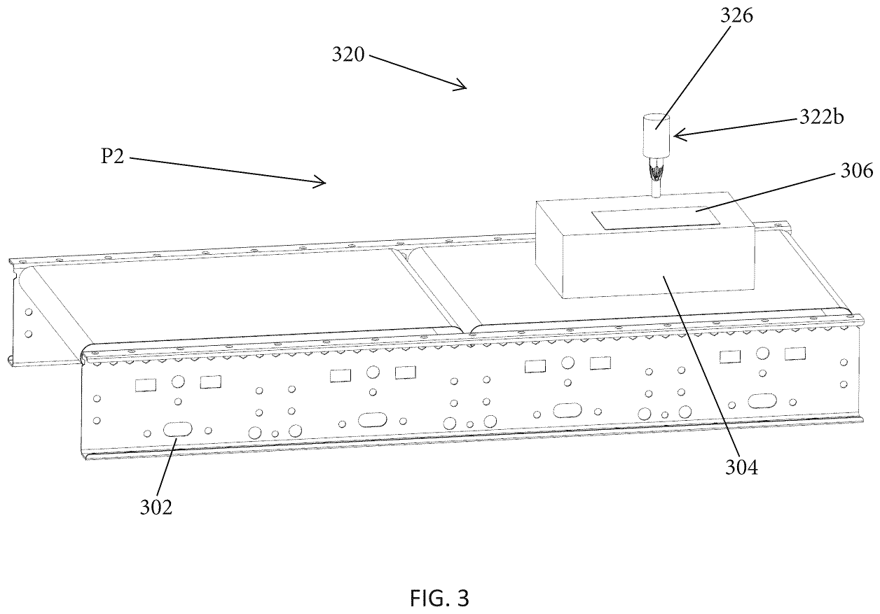

FIG. 3 depicts a third label printer applicator system 320 with a second label applicator module 322b in which a head 326 comprising a swirl air jet head is provided. For exemplary details of the first label applicator module of label printer applicator system 320, reference is made to the first embodiment. Unlike from the previous heads 126, 226, head 326 creates a concentrated jet of air as it leaves the head 326 enabling a more targeted, effective air force impinged on label 306 and pushes air bubbles beneath the label 306 radially outside from the point of impingement, thus, firmly and evenly affixes the label 306 onto the asset 304.

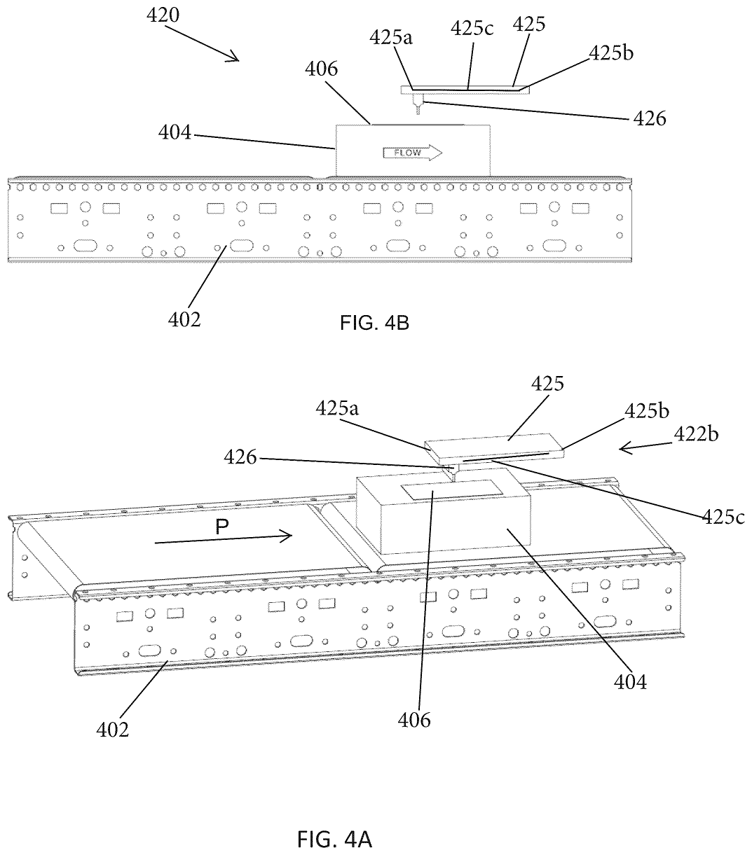

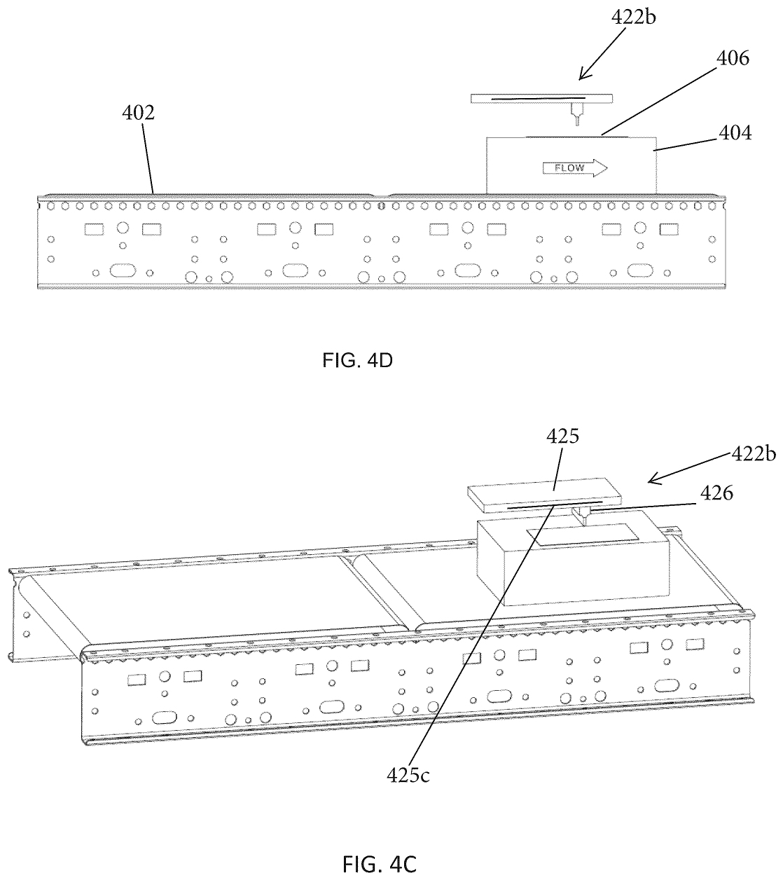

FIGS. 4A, 4B, 4C, and 4D depict a fourth label printer applicator system 420 with a second label applicator module 422b which includes a head 426 that is configured to slide. For exemplary details of the first label applicator module of label printer applicator system 420, reference is made to the first embodiment. Second label applicator module 422b includes a housing 425 with a slotted opening 425c for receiving head 426. Head 426 may be initially mounted in slotted opening 425c at an intermediate position along slotted opening 425c, whose longitudinal dimension allows for head 426 to travel back and forth along the slotted opening 425c. As the asset 404 travels in a direction P of (FIG. 4A) the conveyor belt, head 426 of the second label applicator module 422b is activated and travels forward within the slotted opening 425c until it reaches end wall 425b of the slotted opening 425c and then travels backward until it reaches opposite end wall 425a of the slotted opening 425 before it returns to the original position or standby position. Air flows through the head 426 and impinges on the label 406 evenly to affix the label 406 while the head 426 travels in the forward-back-forward direction.

Although the overall travel distance of the head within the slot opening 425c is set, it is possible to adjust the overall travel distance according to the length or shape of the label. In one embodiment, the overall travel distance is 30% longer than the length of the label, 50% longer than the length of the label, 70% longer than the length of the label, 10% shorter than the length of the label, 30% shorter than the length of the label, or any suitable overall travel distance to accommodate the various design configurations without departing the scope of the disclosure.

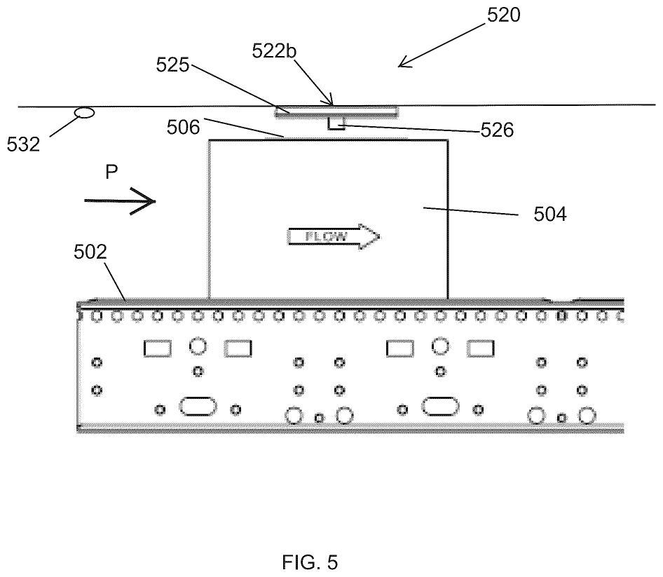

FIG. 5 depicts a fifth label printer applicator system 520 with a second label applicator module 522b. Second label applicator module 522b includes a housing 525, which supports at least one head 526, and a sensing device 532. For exemplary details of the first label applicator module of label printer applicator system 520, reference is made to the first embodiment. The sensing device 532 can include a proximity sensor, a motion sensor, or the like. The proximity sensor can detect when the asset 504 is within a close proximity of the second label applicator module 522b and generates a signal, such as an analog signal based on the proximity of the detected asset 504 to the sensing device 532. The sensing device 532 can include an ultrasonic motion sensor, a microwave motion sensor, or any motion-sensing technology. When the asset 504 moves in front of the second label printer applicator module 522b, sensing device 532 can detect the motion and can generate for example, a binary value, an analog value, or digital value that indicates for example, the asset 504 has been detected, a change in an ultrasonic measurement, or a change in a microwave measurement. In one embodiment, the sensing device 532 is positioned between the first and second label applicator modules 122a, 522b. In another embodiment, the sensing device 532 is positioned before the first label printed applicator module 122a. In yet another embodiment, the sensing device 532 is integrated into the second label printed applicator module 522b.

The controller (not shown) can periodically monitor the state of the sensing device 532 of the second label applicator module 522b at predefined intervals. In response to the detected asset 504, the head 526 is activated and performs a curing process on the label 506 to affix the rest of the label 506.

In some implementations, a label recognition sensor or a profile sensor (not shown) may be provided for detecting whether the label 106, 206, 306, 406, 506 is firmly affixed to the asset 104, 204, 304, 304, 404, 504. In another example, the label recognition sensor or a profile sensor may detect other irregularities, such as, bumps caused by air bubbles, air pockets, or debris beneath the label 106, 206, 306, 406, 506. The irregularities may further be wrinkling, misalignments, defects, curling on sides or edges, or the like of the label 106, 206, 306, 406, 506. The second label applicator modules 122b, 222b, 322b, 422b, 522b, may act as reinforcement modules to remove or eliminate irregularities via performing a process on the label 106, 206, 306, 406, 506.

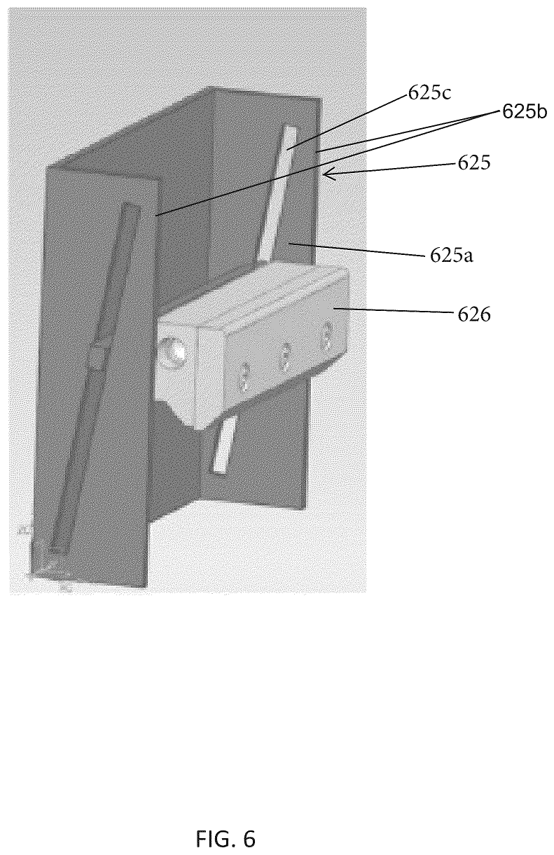

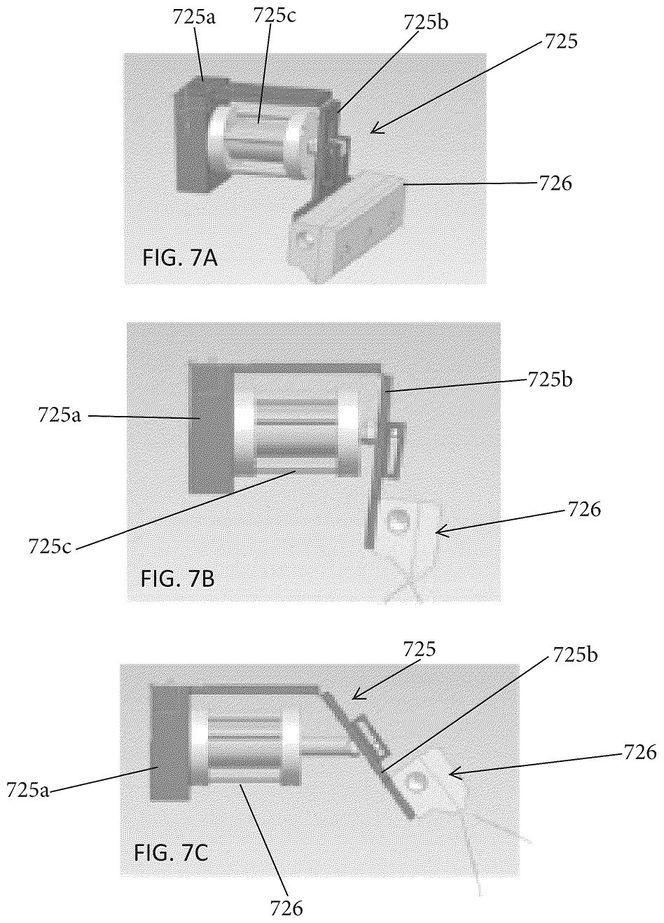

In some implementations, the second label applicator module may comprise a mechanical device that is moved into and out of engagement with the respective label, as depicted in FIGS. 6, 7A and 7B-7C. Though illustrated as fluid flow devices, heads 626 and 726 shown in FIGS. 6, 7A, 7B, and 7C may comprise low friction bearing surfaces, such as rollers, which are moved toward or away from the respective label 106.

Optionally, as best seen in FIG. 6, head 626 may be supported over the packages and labels by a mount 625. Mount 625 may comprise a bracket 626a, such as a channel shaped bracket, with slotted openings 625c formed in its vertical webs 625b so that head 626 can be raised or lowered via an actuator (not shown) toward the label to apply air or apply pressure to the label. In its mechanical form, head 626 may include a roller to engage the label. In its pneumatic form, head 626 may include a nozzle, a knife blower, a fan, or the like.

Referring to FIGS. 7A, 7B, and 7C, head 726 is similarly mounted so that it moves toward or away from label 106. In this embodiment, head 726 is also supported by a mount 725 above the asset 104 and label 106. Mount 725 may comprise a bracket 725a with an articulatable arm 725b that supports head 726. Articulatable arm 725b may be moved, for example, by an actuator 725c that extends and contracts to move head 726 from a first position to a second position where head 726 is moved closer to label 106 or in contact with label 106. For example, in the illustrated embodiment actuator 725c pivots articulatable arm 725b.

In its mechanical form, head 726 may include a low friction bearing surface, such as roller. In its pneumatic form, head 726 may include a nozzle, an air knife blower, a fan, or the like.

In each of the above fluid-based label applicator modules, the heads may each comprise a nozzle, an air knife blower, a fan, or the like. In the case of a fan or blower, the fan or blower may be controlled by the controller. In the case of a nozzle or air knife blower, the head of the label applicator module may be in fluid communication with a pneumatic system that delivers air to the head, which is controlled by the controller. For example, the pneumatic system may include an air delivery device, such as a blower or a pump, which delivers air to the respective heads (126) via conduits, such as tubing or hoses. In the case of air knife blowers, the pneumatic system may deliver compressed air to the blower. For example, the pneumatic system may include a plenum, which is in fluid communication with the air delivery device and the heads, or a manifold, which is in fluid communication with the air delivery device and the heads, where air is delivered to each head so that the air to the respective heads may be individually controlled.

It will be appreciated that numerous variations to the above-mentioned approaches are possible. Variations to the above approaches may, for example, include performing the above steps in a different order.

While certain exemplary embodiments have been described and shown in the accompanying drawings, it is to be understood that such embodiments are merely illustrative of are not restrictive on the broad disclosure, and that this disclosure is not limited to the specific constructions and arrangements shown and described, since various other modifications may occur to those of ordinary skill in the art. The description is thus to be regarded as illustrative instead of limited.

What is claimed is:

1. A conveyor system for labeling a plurality of assets, said conveyor system comprising:
a conveyor for conveying one or more assets; and
a label printer applicator system located above the conveyor comprising:
a first label applicator module configured to print a label, affix the printed label to one or more assets; and
a second label applicator module spaced apart from the first applicator module, the second applicator module for delivering fluid flow along an outer region of the printed label to correct irregularities formed around the outer region.

2. The conveyor system of claim 1 wherein the irregularities comprises at least one of wrinkling, misalignments, defects, or curling.

3. The conveyor system of claim 1 wherein the second label applicator module comprises a head for delivery the fluid.

4. The conveyor system of claim 3 wherein the head comprises at least one of a head selected from the group consisting of a single head, a dual head, a swirl air jet head, and a sliding head.

5. The conveyor system of claim 4 further comprising a sensing device coupled to one of the first and second label applicator modules for detecting one or more assets to be conveyed.

6. The conveyor system of claim 5 wherein the sensing device comprises at least one of a sensor selected from the group consisting of a proximity sensor, a motion sensor, and a label recognition sensor.

7. The conveyor system of claim 5 further comprising a slot opening for receiving the head, wherein the head is configured to slide from a first position, a second position, and return to the first position while the asset is moving in a traveling direction, wherein the head slides to a third position while the asset continues to move in the traveling direction.

8. The conveyor system of claim 7 wherein the sensing device is coupled to the second label applicator module for detecting the asset after exiting the first label applicator module.

9. A conveyor system for labeling a plurality of assets, said conveyor system comprising:
a conveyor for conveying one or more assets; and
a label printer applicator system located above the conveyor comprising:
a first label applicator module configured to print a label and apply the printed label to one or more assets; and
a second label applicator module spaced apart from the first label applicator module, the second label applicator module for delivering fluid flow toward the upper side of the printed label configured to remove irregularities formed on or under the printed label.

10. The conveyor system of claim 9 wherein the irregularities is selected from a group consisting of air bubbles, air pockets, and debris.

11. The conveyor system of claim 9 wherein the second label applicator module comprising a head for delivery the fluid.

12. The conveyor system of claim 11 wherein the head comprises at least one head selected from the group consisting of a single head, a dual head, a swirl air jet head, and a sliding head.

13. The conveyor system of labeling plurality of assets of claim 12 further comprising a sensing device coupled to one of the first and second label applicator modules for detecting one or more assets to be conveyed.

14. The conveyor system of claim 13 wherein the sensing device comprises at least one sensor selected from the group consisting of a proximity sensor, a motion sensor, and a label recognition sensor.

15. The conveyor system of claim 13 further comprising a slot opening for receiving the head, the head is configured to slide from a first position, a second position, and return to the first position while the asset is moving in a traveling direction, wherein the head slides to a third position while the asset continues to move in the traveling direction.

16. The conveyor system of claim 15 wherein the sensing device is coupled to the second label applicator module for detecting the asset after exiting the first label applicator module.

17. A method of labeling an asset supported on a conveyor, said method comprising:
printing a label;
affixing the printed label to an asset at a first location along the conveyor;
transporting the asset to second location along the conveyor; and
delivering fluid flow to at least a region of the printed label when the asset is transported to the second location to correct irregularities formed in the label.

18. The method according to claim 17, wherein said delivering fluid to at least a region includes delivering fluid along an outer region of the label.

19. The method according to claim 17, wherein said delivering fluid includes swirling the fluid as it is delivered to at least a region of the printed label.

20. The method according to claim 17, wherein said delivering fluid to at least a region includes delivering fluid to an upper side of the label.

21. A label printer applicator system for positioning adjacent a conveyor, said label printer applicator system comprising:
a label applicator module having a
a housing; and
a head supported relative to said housing, and said head being configured to direct air flow to at least a region of a label position below said label applicator module to correct irregularities formed around the region.

22. The label printer applicator system according to claim 21, wherein said head is configured to direct air to an outer region of the label, and optionally the head is selected from the group consisting a nozzle, an air knife blower, and a fan.
